(19) United States
(12) Patent Application Publication
(10) Pub. No.: US 2009/0243796 A1
(43) Pub. Date: Oct. 1, 2009

(54) Adaptive power keyless fob

(76) Inventor: Craig A. Tieman, Westfield, IN (US)

Correspondence Address: DELPHI TECHNOLOGIES, INC., M/C 480-410-202, PO BOX 5052, TROY, MI, 48007, US

(21) Appl. No.: 12/079,771

(22) Filed: Mar. 28, 2008

(51) Int. Cl. G08B 29/00

(52) U.S. Cl. 340/5.72

(57) ABSTRACT

A method and apparatus for remotely activating vehicle control functions using a controller mounted in a vehicle and a remote keyless entry device having transmitter, a power source and at least one activatable input member corresponding to a vehicle control function. In response activation of an input member, a remote keyless entry control transmits a vehicle control function signal to the controller at a first transmitter power level. The control determines the distance between the controller and the remote keyless entry device and adjusts the transmitter power level to the minimum power level required to support communication between the controller and the remote keyless entry device. In one aspect, the control, in response to the absence of the return signal from the controller of predetermined signal strength, increases the transmitter power magnitude to a second power magnitude and retransmits the control signal. In an other aspect, the control generates the first control signal at a first high power level and decreases the power level in proportion to the magnitude of the return signal received from the controller.

### BACKGROUND

The present invention relates, in general, to remote keyless entry (RKE) system fobs. Wireless key fobs are widely used for vehicle access and to remotely control vehicle functions, such as locking or unlocking the door, remote engine starting, flashing of emergency horns and lights, as well as to control, locate and provide information feedback. The use of such wireless key fobs is being extended to longer range, bi-directional date transmission, and information displays on the fob. From 111a, just copy over its entire background.

With these added capabilities comes much greater power consumption and requirements for a new battery and power management strategies. Rechargeable batteries and various forms of recharging methods will add cost and weight to the fob as well as the need for periodic recharging.

### SUMMARY

A method and apparatus for remotely controlling a vehicle control functions from a remote entry device and a remote keyless entry device mountable in a vehicle.

The method includes the steps of transmitting a vehicle function control signal from a remote entry device to the controller at a first transmitter power level; determining the distance between the controller and the remote entry device; and in response to the determined distance, adjusting the transmitter power level to the minimum power level required to support communication between the remote entry device and the controller.

The step of adjusting the transmitter power level further comprises the step of in the absence of a return signal from a controller to the remote entry device of a predetermined signal strength, changing magnitude of the transmitter power level by a determined amount to a different power level.

The step of adjusting the transmitter power level also comprises the steps of: generating a first control signal to a first high transmitter power level and decreasing the transmitter power level in proportion to discrete preset successively decreasing levels to the magnitude of a return signal from the controller.

The method also includes the step of activating predetermined vehicle control functions dependant upon a distance determined by the controller between the controller and the remote entry device.

The vehicle remote keyless entry apparatus includes a remote keyless entry control adapted to be mounted in a vehicle to convert wireless signals from a remote entry device to actuation of vehicle control function; a transmitter and receiver coupled to the control; a remote keyless entry device having a transmitter and a receiver; at least one input member carried on the remote entry device for causing the remote keyless entry device to generate a control signal corresponding to a vehicle control function corresponding to at least one input member; a power source carried in the remote keyless entry device for providing power to the transmitter to transmit signals to the controller, the power source providing selectable transmitter power magnitudes; a control in the remote keyless entry device selecting a first power magnitude from the power source for the remote keyless entry device control upon activation of at least one input member; and the remote keyless entry device control operating to adjust the transmitter power level to the minimum power level required to support communication between the remote keyless entry device and the controller.

The remote keyless entry device control responsive to a signal strength of a return signal from the remote keyless entry control.

The control of the supply of power to the transmitter for re-transmitting the control signal corresponding to activation of at least one input member at the second different power magnitude level.

The apparatus also includes means for controlling the supply of power to the transmitter in response to activation of at least one input member at a first high power level and decreasing the power level in proportion for discrete preset successive decreasing levels to the magnitude of the return signal received by the remote keyless entry device control from the remote keyless entry control.

The control may activate vehicle control function dependent upon the distance determined by the control between the control and the remote keyless entry device.

### BRIEF DESCRIPTION OF THE DRAWING

The various features, advantages, and other uses of the present invention will become more apparent by referring to the following detailed description and drawing in which:

FIG. 1 is a pictorial representation of a vehicle remote keyless entry receiver and a remote fob;

FIG. 2 is a block diagram of the control circuitry of the fob;

FIG. 3 is a block diagram of the control circuitry for the vehicle RKE;

FIG. 4 is a graph depicting the sequence of fob signal transmission power levels relative to the distance between the fob and the vehicle RKE; and

FIG. 5 is a graph depicting another aspect of the fob signal transmitter power level sequence relative to the distance between the fob and the vehicle RKE.

### DETAILED DESCRIPTION

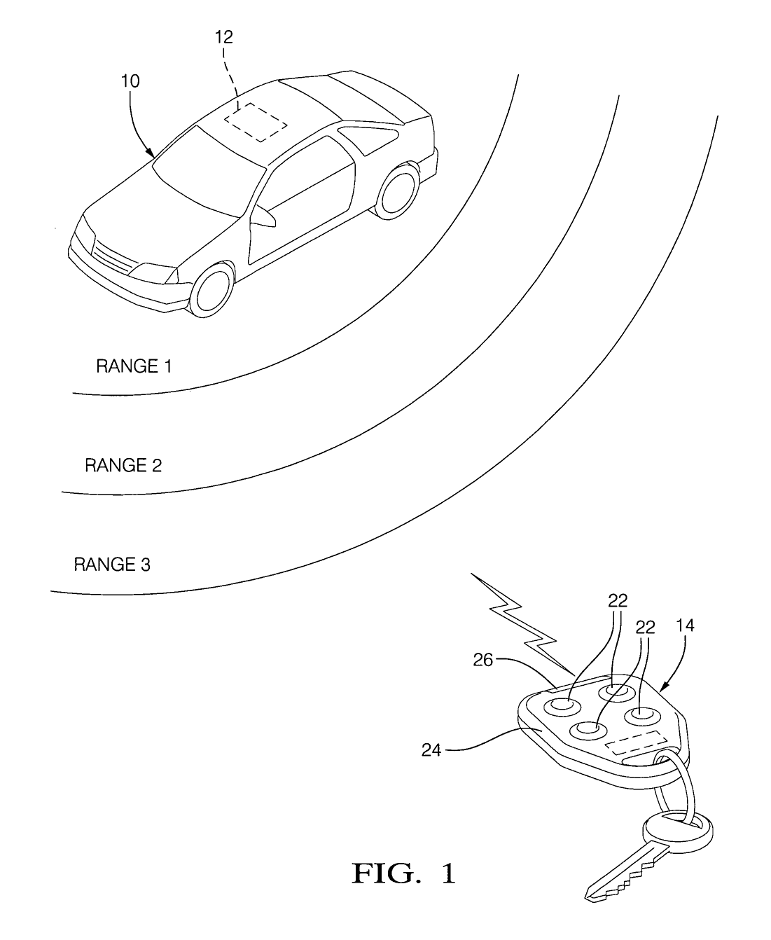

Referring now to the drawing, and to FIGS. 1, 2 and 3 in particular, there is depicted a vehicle 10 having a remote keyless entry or RKE apparatus 12 mounted therein. A wireless key fob and transmitter 14 is associated with the RKE 12 and is identifiable by a unique frequency match to enable only the fob 14 to transmit signals to the RKE 12 which are recognized by the RKE 12 as being valid for vehicle control functions.

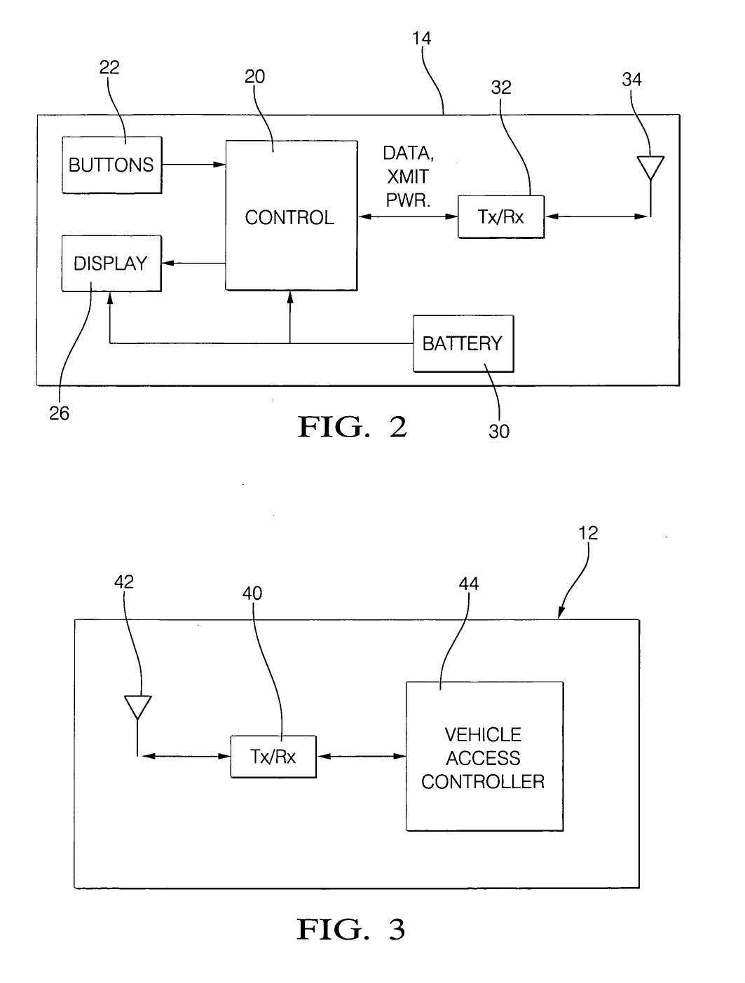

As shown in detail in FIG. 2, the fob 14 includes a control 20, which may be a processor based control executing a control program stored in a memory. One or more input members or buttons 22 are mounted on the housing 24 of the fob 14. The input members or buttons 22 are associated with a particular vehicle function, such as locking or unlocking the vehicle doors and/or trunk or hatch, lowering the vehicle windows, remotely starting the vehicle engine, flashing the vehicle horns and/or lights, etc. A display 26 may also be mounted in the fob housing 24 to display vehicle status or button 20 selection information.

It will be understood that the shape of the fob housing 24, the number and functions designated by the buttons 22, the addition or non-provision of the display 26 can have any configuration.

A power supply, such as a battery 30, is contained in the housing 24 for powering the components of the fob 14 as shown in FIG. 2. A transmitter or a transmitter/receiver, transceiver or transponder 32 is mounted in the housing 24 for transmitting a data signal generated by the control 20 in response to depression or activation of one of the buttons 22. The transmitter 32 has a frequency of operation between 300 MHz to 450 MHz, for example only.

The user depresses or activates one of the buttons 22 associated with the desired vehicle function that the user wishes to initiate. The input signal from the button 22 wakes up or activates the processor in the control 20 which outputs a data stream to the transmitter 32. The data stream may include a data preamble, the actual vehicle function command, i.e., unlock vehicle doors, etc., an optional rolling code for vehicle to vehicle security, and possibly one or more check bits. This signal is sent by the transmitter 32 through an antenna 34 to the RKE 12 where it is received by a receiver 40 through an antenna 42. The signal is demodulated by a vehicle access controller 44 which may also a microprocessor based controller 44. The controller 44 outputs a signal to a vehicle function control device or to a vehicle body computer which implements the desired vehicle function.

As is easily apparent, a long life for the battery 30 in the fob 14 is important. At the same time, the fob 14 must remain lightweight and small in size for easy portability and storage in a user's pocket, or purse, or on the user's key ring. To minimize power requirements for each signal transmitted by the transmitter 32 of the fob 14 and to meet FCC wireless signal interference requirements, the power level or magnitude of the signal sent by the fob transmitter 32 has a prescribed maximum. This creates a distance between the fob 14 and the vehicle RKE 12 within which the signal from the fob 14 will be received by the vehicle RKE 12; but beyond which the strength of the signal transmitted by the fob 14 will be too low to be received or recognized as a valid signal by the receiver 12. This distance can be from 1 to 10 meters. The distance can be increased to 10 to 20 meters, or more for example, by increasing the signal strength or power magnitude of the signal sent by the fob transmitter 32, but excessive battery power consumption must then be considered.

As shown in FIG. 1, the fob 14 utilizes an adapted transmission power scheme to enhance battery life in unidirectional or bidirectional fob systems. The adaptive transmission power scheme is based on the premise that only enough power is utilized to cover the distance between the vehicle RKE 12 and the fob 14 as necessary and any higher power level which wastes battery power is unnecessary.

As shown in FIG. 1, four ranges or zones labeled range 1, range 2, range 3 and range 4 are established in a radial direction from the vehicle RKE 12 which is used as a center point. The radial distance of each range may vary depending upon the fob battery 30 power level and application requirements, but by way of example only to understand the adaptive transmission power scheme, range 1 is 1 to 30 meters, range 2 is 30 to 100 meters, range 3 is 100 to 500 meters and range 4 is any distance greater than 500 meters from the vehicle RKE 12.

Also for purposes of this discussion, the maximum power of the signal transmitted by the transmitter 32 of the fob 14 will be insufficient to constitute a valid signal which can be received and recognized by the vehicle RKE 12 when the distance between the RKE 12 and the fob 14 is greater than 800 meters.

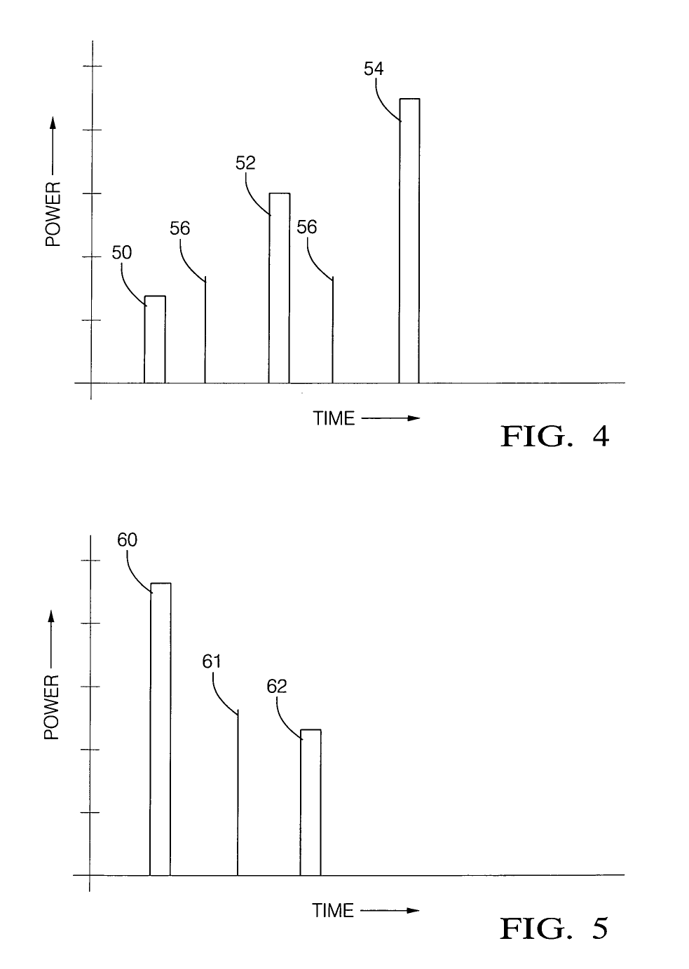

In one aspect, a power level adjustment means is provided in control 30 to regulate the magnitude of power supplied by the battery 30 to the fob RKE transmitter 32. Three reset power levels 50, 52 and 54, i.e., low, medium and high, respectively, are shown by way of example only in FIG. 4.

Two to four or more preset power levels may be provided. Alternatively, the power level adjustment means may increment the power level in incremental steps starting with the low power level.

According to one aspect of the adaptive transmission power scheme, when the user presses one of the buttons 22 on the fob 14 to communicate with the vehicle RKE 12, an initial low power level 50 is selected by the control 20 and supplied to the transmitter 32 for transmitting a RF signal containing data pertaining to the button 22 which was pressed, authentication data, check bits, etc. The receiver or transceiver in the fob 14 waits briefly for an acknowledgement or return signal to be sent by the vehicle access controller 44 in the RKE 12 through the RKE transmitter 40. If this return signal, which is an indication that the vehicle RKE received and was able to decode the signal from the fob transmitter 32, is not received within a predetermined time, such as two seconds, the fob control 20 increases the power of the signal transmission to the next preset or medium power level 52 and retransmits the same signal containing data corresponding to the button 22 which was pressed by the user. It should be noted that the user does not have to take any additional action to repress the same button 22. The control 20 again awaits for a predetermined time, i.e., two seconds, for example, for the return signal from the RKE 12.

If the return signal is not received with the predetermined time, the control 20 increases the power level to the next or third high power level 54 and again retransmits the signal through the transmitter 32 to the vehicle RKE. If a return signal 56 is received within a predetermined time by the fob control 20, the high power level 54 is maintained for any subsequent signal transmissions by the fob 14 within a predetermined time defining a signal activation sequence or series of events.

It will be understood that if the distance between the fob 14 and the RKE 12 is within range 2, a return signal from the vehicle RKE would have been received after the fob 14 transmitted a signal at the medium power level 52. Likewise, if the fob 14 is located within range 1 to the RKE 12, a low power level signal 50 would have enabled a valid return signal to be received by the fob control 20.

The sequence of actions of the successive power level variations can be presented by the control 20 on the fob display 26, either in a form of text messages, such as “transmitting at low power level”, “transmitting at medium power level”, “transmitting at high power level”, etc. In addition, a no signal message could be presented when the fob 14 is located beyond range 4 from the RKE 12 which would be an indication to the user that he or she would have to move closer to the vehicle to implement the desired remote access functions through the fob 14.

Referring now to FIG. 5, another aspect of the adaptive transmission power scheme is disclosed. In this aspect, upon an initial depression of one of the fob buttons 22, an initial high power level burst 60 is applied by the control 20 for transmission to the transmitter 32 to the RKE 12. The control 20 then awaits for a return signal from the RKE 12. If the vehicle RKE 12 responded within the time period, the signal strength of the return signal from the vehicle RKE which is proportional to the distance between the RKE 12 and the fob 14, is determined by the control 20 and subsequent transmissions from the fob 14 will take place at a power level proportional to the lowest power level which was determined from the measured signal strength of the return signal from the vehicle RKE 12. The power levels associated with incremental return signal strengths can be provided in a lookup table in the memory accessed by the control 20 or by a simple voltage proportioning circuit in which the ratio of the signal strength of the return signal to the maximum power level 60 of the initial signal transmitted by the fob transmitter 32 would be determined and the fob transmitter 32 power level reduced proportionately.

This adaptive transmission power scheme takes into account the various ranges 1-3 in that the initial high power level burst 62 will always generate a return signal from the RKE when the fob 14 is within ranges 1, 2 or 3 from the vehicle RKE 12. However, any subsequent signal transmissions from the fob 14 will be at the minimum power level required to successfully transmit the signal from the fob 14 to the vehicle RKE 12 thereby using only the lowest possible fob 14 battery power.

In conclusion, the fob transmitter power is matched by the adaptive transmission power scheme described above to the estimated effective range for each fob signal transmission. This ensures that wireless signals are successfully transmitted between the fob 14 and the RKE 12 within the various effective ranges of signal communications established for the particular fob 14 and RKE 12 at the lowest possible fob power level. This conserves battery power and extends the life of the battery.

It will be understood that the example of both aspects of the adaptive transmission power scheme described above which utilizes by way of example only the ranges 1, 2, 3 and 4 was described for an RKE system wherein any of the possible vehicle functions assessable by the fob buttons 22 can be selected and activated when a signal corresponding to a button 22 depression is successfully transmitted by the fob transmitter 32 to the vehicle RKE 12. It is also possible, for example, to enable any single or group of vehicle control functions, such as a remote engine start signal, to be successfully completed only when the user is within a particular range or ranges. Similarly, the RKE 12 can be programmed to recognize and process signals from the fob 14 at a power level consistent with ranges 2 or 3 to unlock vehicle doors, lower vehicle windows, etc. Similarly, the maximum range 3 would allow successful signal completion between the fob 14 and the RKE 12 only for emergency activation of the vehicle horns or lights or to assist the user in locating the vehicle.

Thus, the control 20 could operate according to the first aspect of the adaptive transmission power scheme for any button 22 or vehicle control function which may be selected by the user. The second aspect could still be implemented with an initial high power level signal 60, but the subsequent reduction and signal power strength based on the return signal strength will be divided into ranges 1, 2 and 3 depending upon which button or control function is selected by the user. For example, if the user is within range 3 from the RKE 12, and depresses the door unlock button, even though the signal strength of the return signal from the RKE would cause the fob control 20 to implement the subsequent signal transmissions to a certain power level, such reduced power level signals will not be successfully received by the RKE until the fob 14 is located within the prescribed range 1, 2 or 3 from the RKE 12 for the selected functions.

What is claimed is:

1. A method of activating vehicle control functions from a remote entry device incorporating a remote key less entry controller to control activation of vehicle control functions, the method comprising the steps of:
transmitting a vehicle function control signal from a remote entry device to the controller at a first transmitter power level;
determining the distance between the controller and the remote entry device;
in response to the determined distance, adjusting the transmitter power level to the minimum power level required to support communication between the remote entry device and the controller.

2. The method of claim 1 wherein the step of adjusting the transmitter power level further comprises the step of:
in the absence of a return signal from a controller to the remote entry device of a predetermined signal strength, increasing the magnitude of the transmitter power level by a first determined amount to a second power level.

3. The method of claim 2 further comprising the step of: in the absence of a return signal from the controller to the remote entry device of a predetermined signal strength in response to the transmission of a control signal from the remote entry device to the controller at the second power level, increasing the transmitter power by a second predetermined amount to a third power level.

4. A method of claim 1 wherein the step of adjusting the transmitter power level comprises the steps of:
generating a first control signal at a first high transmitter power level; and
decreasing the transmitter power level in proportion to the magnitude of a return signal from the controller.

5. The method of claim 4 wherein further comprising the step of:
decreasing the transmitter power level in discrete preset successively decreasing levels.

6. Method of claim 1 further comprising the step of: activating predetermined vehicle control functions dependant upon a distance determined by the controller between the controller and the remote entry device.

7. The method of claim 1 further comprises the steps of:
determining by the controller the distance between the controller and the remote entry device; and
activating selected vehicle control functions in response to the control signal from the remote entry device dependent on the distance between the controller and the remote entry device.

8. The method of claim 7 further comprising the step of:
activating at least one vehicle control function only within a predetermined distance range between the controller and the remote entry device.

9. A vehicle remote keyless entry apparatus for activating vehicle control
functions from a remote entry device incorporating a remote key less entry controller to control activation of vehicle control functions comprising:
means for transmitting a vehicle function control signal from a remote entry device to the controller at a first transmitter power level;
determining the distance between the controller and the remote entry device; and
in response to the determined distance, adjusting the transmitter power level to the minimum power level required to support communication between the remote entry device and the controller.

10. A vehicle remote keyless entry apparatus comprising:
a remote keyless entry control adapted to be mounted in a vehicle to convert wireless signals from a remote entry device to actuation of vehicle control function;
a transmitter and receiver coupled to the control;
a remote keyless entry device having a transmitter and a receiver;
at least one input member carried on the remote entry device for causing the remote keyless entry device to generate a control signal corresponding to a vehicle control function corresponding to at least one input member;
a power source carried in the remote keyless entry device for providing power to the transmitter to transmit signals to the controller, the power source providing selectable transmitter power magnitudes;
a control in the remote keyless entry device selecting a first power magnitude from the power source for the remote keyless entry device control upon activation of at least one input member; and
the remote keyless entry device control operating to adjust the transmitter power level to the minimum power level required to support communication between the remote keyless entry device and the controller.

11. The apparatus of claim 10 further comprising:
the control responsive to a signal strength of a return signal from the remote keyless entry control.

12. The apparatus of claim 11 wherein:
the control of the supply of power to the transmitter for re-transmitting the control signal corresponding to activation of at least one input member at the second different power magnitude level.

13. The apparatus of claim 12 wherein:
the control of the supply of power to the transmitter for re-transmitting the control signal corresponding to activation of at least one input member at the third different power magnitude level.

14. The apparatus of claim 10 wherein the remote keyless entry device control further comprises:
means for controlling the supply of power to the transmitter in response to activation of at least one input member at a first high power level and decreasing the power level in proportion to the magnitude of the return signal received by the remote keyless entry device control from the remote keyless entry control.

15. The apparatus of claim 14 further comprising:
the control decreasing the power level supplied to the transmitter in discrete preset successive decreasing levels in response to the signal strength of the return signal from the controller.

16. The apparatus of claim 10 wherein:
the remote keyless entry control activates vehicle control function dependent upon the distance determined by the control between the control and the remote keyless entry device.

17. The apparatus of claim 16 further comprising:
the controller activating at least one vehicle control function only when the distance between the remote keyless entry control and the remote keyless entry device is within a pre-determined range.
